(19) United States
(12) Patent Application Publication
(10) Pub. No.: US 2022/0411096 A1
(43) Pub. Date: Dec. 29, 2022

(54) OVEN WITH AIR QUALITY SENSOR

(71) Applicant: B/E Aerospace, Inc., Winston Salem, NC (US)

(72) Inventors: Hans HUIJSING, IJsselstein UT (NL); Manuel Perez Camacho, Nieuwegein (NL)

(21) Appl. No.: 17/831,901

(22) Filed: Jun. 3, 2022

(30) Foreign Application Priority Data
Jun. 28, 2021 (EP) 21181983.4

(51) Int. Cl. B64D 45/00; B64D 11/04; F24C 15/00

(52) U.S. Cl. CPC B64D 45/00; B64D 11/04; F24C 15/006

(57) ABSTRACT

An oven for an aircraft. The oven is situated in a cabin of the aircraft and the oven comprises an air flow, and at least one sensor provided downstream of the air flow, said at least one sensor configured to determine a gas composition of the air flow.

### CROSS REFERENCE TO RELATED APPLICATIONS

This application claims priority to European Patent Application No. 21181983.4 filed Jun. 28, 2021, the entire contents of which is incorporated herein by reference.

### TECHNICAL FIELD

The present disclosure relates to an oven with one or more air quality sensors.

### BACKGROUND

Ovens are used on aircraft to heat/cook meals to distribute to passengers travelling to their intended destination. Various detectors in an aircraft cabin determine if there is smoke present in the air. However, these smoke detectors do not assess the air quality of the aircraft for a prediction of an emergency event.

The present disclosure provides a solution for this need.

### SUMMARY OF THE INVENTION

There is provided an oven for an aircraft. The oven is situated in a cabin of the aircraft. The oven includes an air flow, and at least one sensor provided downstream of the air flow, said at least one sensor configured to determine a gas composition of the air flow.

The oven may further comprise an air inlet and a cooling fan configured to draw air from the cabin through said air inlet. The at least one sensor may be provided downstream of the air inlet. Further, the at least one sensor may be configured to determine the gas composition of the air drawn in from the cabin.

The at least one sensor may be configured to determine whether the gas composition of the air is above a predetermined threshold. The at least one sensor may be configured to identify a hazardous event based on the determination that the gas composition is above a predetermined threshold.

The at least one sensor may be configured to detect at least one of the following gasses: ethane, isoprene, 2-methyl-1,3 butadiene, ethanol, acetone and carbon monoxide.

The at least one sensor may be configured to detect at least one of air pressure, a temperature of the air and a humidity of the air.

The oven may further comprise a human-machine interface. The at least one sensor may be configured to send a signal to the human-machine interface to display a hazardous event.

The at least one sensor may be located in an outer cavity of the oven.

There is also provided an aircraft galley, comprising the oven described above.

The aircraft galley may further comprise an aircraft galley network. The at least one sensor may be configured to send a signal to the aircraft galley network in order to alert of a hazardous event.

There is also provided a method. The method include providing an oven for an aircraft, the oven including an air flow, and at least one sensor provided downstream of the air flow, and wherein said at least one sensor determines the gas composition of the air flow.

The at least one sensor may determine whether the gas composition of the air is above a predetermined threshold, and wherein the at least one sensor may identify a hazardous event based on the determination that the gas composition is above a predetermined threshold.

The at least one sensor may detect at least one of the following gasses: ethane, isoprene, 2-methyl-1,3 butadiene, ethanol, acetone and carbon monoxide.

The at least one sensor may detect at least one of air pressure, a temperature of the air and humidity of the air.

The at least one sensor may send a signal to a human-machine interface of the oven to display a hazardous event.

The at least one sensor may send a signal to an aircraft galley network in order to alert of a hazardous event.

### BRIEF DESCRIPTION OF THE DRAWINGS

FIG. 1a shows an sketch of the main modules of an oven.

FIG. 1b shows a flow representation of the oven of FIG. 1a.

FIG. 1c shows a 3D view of the top of an oven example with part of the outer shell removed.

FIG. 1d shows a top view of an oven with part of the outer shell removed.

FIG. 2a shows a position of a gas composition sensor.

FIG. 2b shows an additional, or alternative, position of a gas composition sensor.

### DETAILED DESCRIPTION

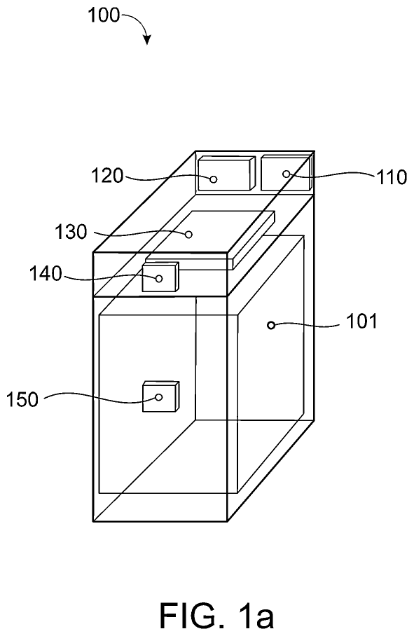

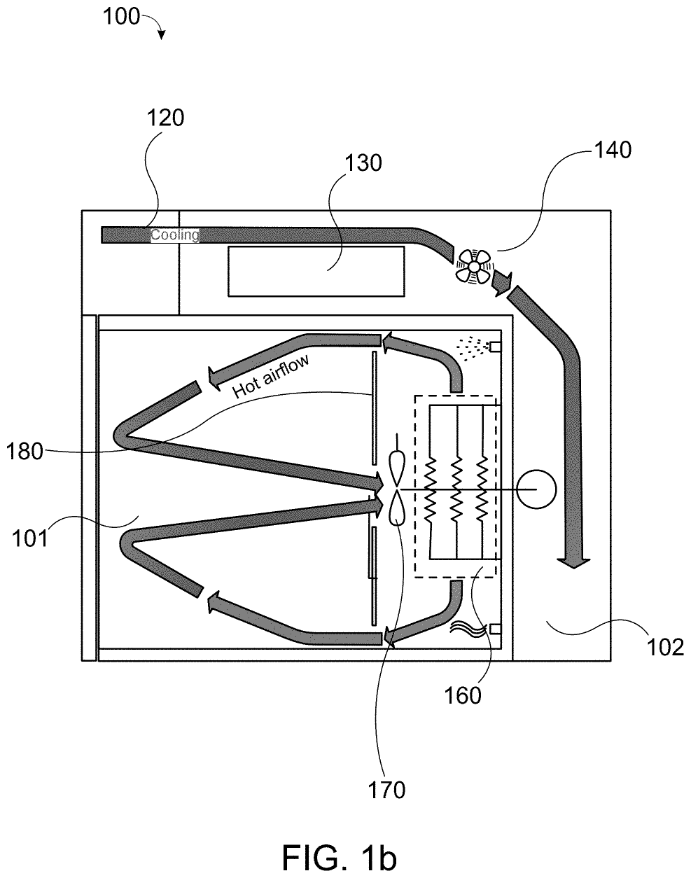

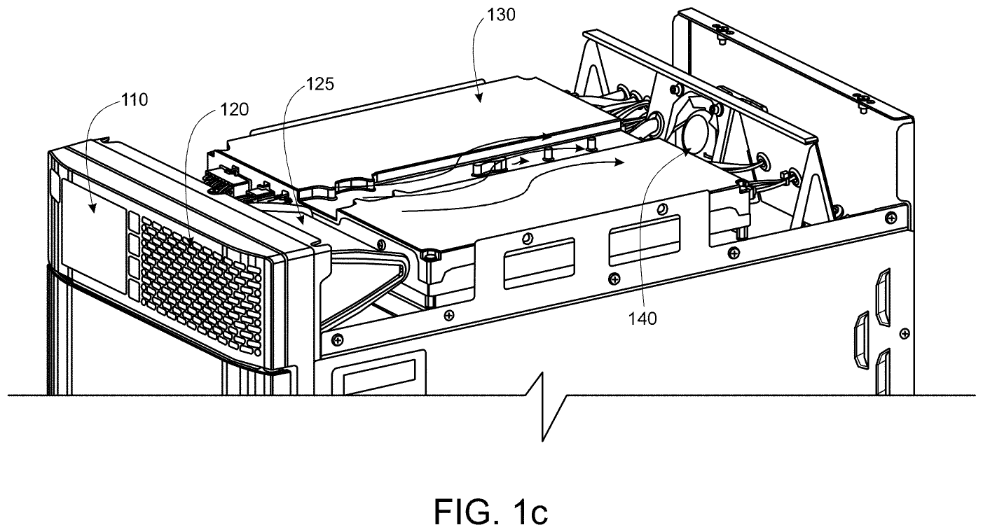

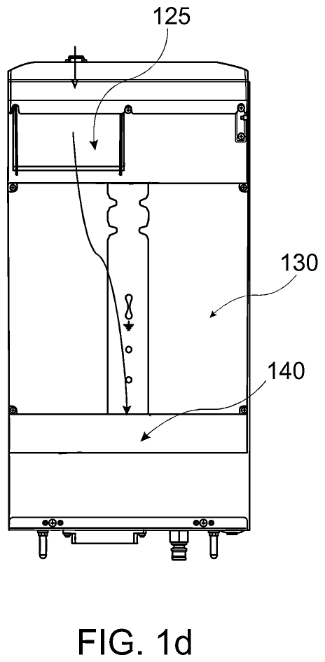

With reference to FIG. 1a, there is shown an oven 100. The oven 100 may include an air inlet 120, a human-machine interface 110 (hereinafter HMI), an oven control unit 130 (hereinafter OCU), a cooling fan 140, an inner cavity 101 and motor 150.

The HMI 110 allows a user to input controls to the oven 100; for example, cooking time, temperature settings, type of meal etc. The HMI 110 also informs the cabin crew over the oven status The air inlet 120 allows for cabin air to pass through from the cabin (not shown) into the oven 100. The OCU 130 communicates with the HMI in order to control the functions of the oven 100 and display relevant information about the oven; for example, setting the cooking time and temperature, etc.

The cooling fan 140 shown in FIG. 1a is configured to draw air in from the cabin and through the air inlet 120 to the outer cavity (not shown in FIG. 1a). Therefore, the cooling fan 140 is drawing in cabin air in order to pass over the OCU 130 such that the OCU 130 remains cool during operation.

The inner cavity 101 is an area in the oven that heats/cooks one or more meals that are introduced into the inner cavity 101 during use. The motor 150 may operate an oven fan (not shown in FIG. 1a) that circulates hot air in the inner cavity 101 to heat/cook the meals that are provided in the inner cavity 101 during use.

FIG. 1b shows a flow representation of the oven 100 of FIG. 1a. As can be seen in FIG. 1b, the oven 100 may include the inner cavity 101 and an outer cavity 102. The air inlet 120, HMI 110, OCU 130, cooling fan 140 and motor 150 may all be present in the outer cavity 102. The inner cavity may include at least one heating element 160, an oven fan 170 and one or more baffle plates 180.

As shown in FIG. 1b, the cooling fan 140 draws cooling air from the aircraft cabin through the air inlet 120. The flow of air moves across the OCU 130 in order to cool the OCU 130 during operation. Therefore, the cooling air moving through the outer cavity prevents crucial components from overheating during use.

As mentioned above, the inner cavity 101 may include at least one heating element 160 that heats the air surrounding the at least one heating element 160 in the interior of the inner cavity 101. The motor 150 is connected to the oven fan 170 in order to rotate the oven fan 170 such that hot air can be circumvented within the inner cavity 101. The oven fan 170, as an example, can draw the hot air around the one or more baffle plate 180 such that there is uniform heating in the interior of the inner cavity 101. This therefore allows for uniform cooking/heating of the passenger meals.

FIG. 1c shows a schematic view of the top of the oven 100 with a part of a shell of the outer cavity removed. As shown in this Figure, there may be provided a dust filter 125 between the air inlet 120 and the OCU 130. The dust filter 125 allows for particles from the cabin air to be removed after passing through the air inlet 120. Therefore, the dust filter 125 ensures that the subsequent air passing over the OCU 130 is free from particles from the cabin.

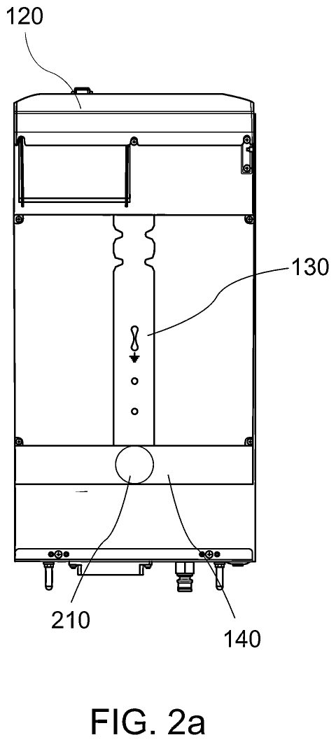

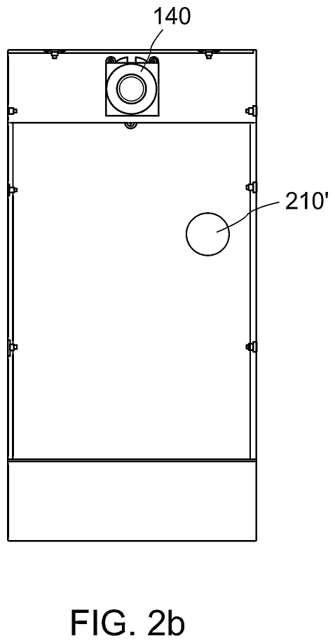

In order to determine if an air flow, for example the air drawn in from the air inlet 120 by the cooling fan 140, includes hazardous gas, a sensor 210 or 210′ (shown in FIGS. 2a and 2b) is provided in or on the oven. The sensors 210 or 210′ may be configured to detect, as an example, ethane, isoprene, 2-methyl-1,3 butadiene, ethanol, acetone, carbon monoxide and other hazardous gas compositions. The sensors 210 and 210′ may also be configured to determine air quality, pressure, humidity and temperature of the air drawn in from the air inlet. In both FIGS. 2a and 2b, the sensors 210, 210′ are provided, as an example, downstream of the inlet air flow drawn in from the air inlet 120 by the cooling fan 140. Of course, it is envisaged that the sensors 210. 210′ may be provided downstream of any air flow that includes potential sources of dangerous gases.

As an example shown in FIG. 2a, the position of the sensor 210 is provided in the outer cavity of the oven downstream of the air inlet 120 and the OCU 130, and is located adjacent to the cooling fan 140. The sensor 210 is configured to monitor the inlet air flow and to determine if hazardous gases are present.

As an example shown in FIG. 2b, the sensor 210′ is located in the outer cavity of the oven downstream of the cooling fan 140. Therefore, the sensor 210′ is configured to monitor the inlet air flow after passing the cooling fan 140 to determine if there are hazardous gases present.

The sensors 210 and 210′ are shown in example locations in FIGS. 2a and 2b. However, it is envisaged that any suitable location of the sensors 210 and 210′ may be configured such that they are positioned to detect potentially hazardous gasses in any air flow within, or around, the oven. The invention is not restricted to these locations and it is to be understood that the sensors 210 and 210′ could be placed in, on, or around, the oven in order to detect hazardous gas in an air flow.

The sensors 210 and 210′ may both be present in the oven. Alternatively, one of the sensors 210 and 210′ may be provided in the oven. Of course, further gas composition sensors may also be included in the system to determine hazardous gases in an air flow, for example to allow detection of potentially hazardous gasses generated by other galley equipment.

Advantageously, the sensors 210 and 210′, as an example, allow for the oven to determine if there are hazardous gasses present in the air flow, which could signify that there is an emergency event in the cabin. The sensors 210 and 210′ may then alert the cabin crew or flight deck of a potentially dangerous event occurring in the cabin whenever the threshold limit of one or more of the hazardous gasses is crossed. The sensors 210 and 210′, for example, could be connected to the OCU 130, and the OCU 130 may be connected to the aircraft galley network and/or other aircraft inserts. The warning message could be displayed in the HMI of the oven and/or communicated to the aircraft and/or other inserts.

Although this disclosure has been described in terms of preferred examples, it should be understood that these examples are illustrative only and that the claims are not limited to those examples. Those skilled in the art will be able to make modifications and alternatives in view of the disclosure which are contemplated as falling within the scope of the appended claims.

1. An oven for an aircraft, said oven being situated in a cabin of the aircraft, the oven comprising:
an air flow; and
at least one sensor provided downstream of the air flow, said at least one sensor configured to determine a gas composition of the air flow.

2. The oven of claim 1, wherein the oven further comprises:
an air inlet; and
a cooling fan configured to draw air from the cabin through said air inlet;
wherein the at least one sensor is provided downstream of the air inlet, and wherein the at least one sensor is configured to determine the gas composition of the air drawn in from the cabin.

3. The oven of claim 1, wherein the at least one sensor is configured to determine whether the gas composition of the air is above a predetermined threshold, and wherein the at least one sensor is configured to identify a hazardous event based on the determination that the gas composition is above a predetermined threshold.

4. The oven of claim 1, wherein the at least one sensor is configured to detect at least one of ethane, isoprene, 2-methyl-1,3 butadiene, ethanol, acetone and carbon monoxide.

5. The oven of claim 1, wherein the at least one sensor is configured to detect at least one of air pressure, a temperature of the air and a humidity of the air.

6. The oven of claim 1, wherein the oven further comprises:
a human-machine interface;
wherein the at least one sensor is configured to send a signal to the human-machine interface to display a hazardous event.

7. The oven of claim 1, wherein the at least one sensor is located in an outer cavity of the oven.

8. An aircraft galley, comprising:
the oven of claim 1.

9. The aircraft galley of claim 8, wherein the aircraft galley further comprises:
an aircraft galley network;
wherein the at least one sensor are configured to send a signal to the aircraft galley network in order to alert of a hazardous event.

10. A method comprising:
providing an oven for an aircraft, the oven comprising:
an air flow; and
at least one sensor provided downstream of the air flow, and wherein said at least one sensor determines a gas composition of the air flow.

11. The method of claim 10, wherein the at least one sensor determines whether the gas composition of the air is above a predetermined threshold, and wherein the at least one sensor identifies a hazardous event based on the determination that the gas composition is above a predetermined threshold.

12. The method of claim 10, wherein the at least one sensor detects at least one of ethane, isoprene, 2-methyl-1,3 butadiene, ethanol, acetone and carbon monoxide.

13. The method of claim 10, wherein the at least one sensor detects at least one of air pressure, a temperature of the air and a humidity of the air.

14. The method of claim 10, wherein the at least one sensor sends a signal to a human-machine interface of the oven to display a hazardous event.

15. The method of claim 10, wherein the at least one sensor sends a signal to an aircraft galley network in order to alert of a hazardous event.
